(19) United States
(12) Patent Application Publication
(10) Pub. No.: US 2024/0114852 A1
(43) Pub. Date: Apr. 11, 2024

(54) NANO-COATED EARTHENWARE COMPARTMENT PLANT PROTECTOR TO ENHANCE PLANT SURVIVAL AND REDUCE THE NEGATIVE EFFECTS OF THE ENVIRONMENTAL STRESSES

(71) Applicants: Adel Bavi, Ahvaz (IR); Ahmad Motiei, Ahvaz (IR)

(72) Inventors: Adel Bavi, Ahvaz (IR); Ahmad Motiei, Ahvaz (IR)

(21) Appl. No.: 17/767,671

(22) PCT Filed: Dec. 11, 2020
(86) PCT No.: PCT/IR2020/050048

§ 371 Date: Apr. 10, 2022

(30) Foreign Application Priority Data
Oct. 15, 2019 (WO) PCT/IR2020/102512

(51) Int. Cl. A01G 13/02; A01G 27/02

(52) U.S. Cl. CPC A01G 13/0243; A01G 27/02

(57) ABSTRACT

The present apparatus is an earthenware compartment having above opening (28) and bottom opening (26), which is made of clay and heated to reach its optimum hardness (FIG. (1) & (2)). Earthenware compartment comprising: a condensation funnel opening (1), a lower part (5) an upper part (3), Nano-seal coating (10), mulching materials (12), and mycorrhizal fungi (6). Each part individually or together with other parts, reduces environmental stresses and increases the survival potential of plants in stressful environmental condition. The functions of this invention comprising: 1—surrounding the plant (3) in order to protect their whole aerial parts (shoot system) from the impacts of environmental stresses (8) & (9), 2—preventing the plants root collar (19) and root zone (15) from the invasion of accumulated salts coming from surrounding soil (16) to the root zone (15), by disconnecting the soil between the root zone (15) and the surrounding soil (17), 3—reducing water requirement of plants by increasing water application efficiency, due to the weight of accumulated water in the water reservoir (4) that pushes water to the lower layers of soil (14) under the earthenware compartment, 4—preventing degraded surrounding soil (16) from entering into the planting holes and reducing their water storage capacity, and 5—motivating the root of plant to follow the moisture downwardly to lower layers of soil, causing the deeper establishment of the planted plant and causing the root system to reach underground water (13) sooner conventional methods of irrigation. The key benefit of the present apparatus is its biocompatible gender, which is made of clay. Therefore, extensive use of this apparatus does not harm the environment; also, it is resistant to environmental stresses such as fast winds, high temperatures, successive wetting and drying due to frequent irrigations, and physical strikes including strikes of animals in deserts. It is also commercially can be competitive due to its low price; additionally, it does not seem to be worthwhile to be stolen, hence, reducing guarding costs.

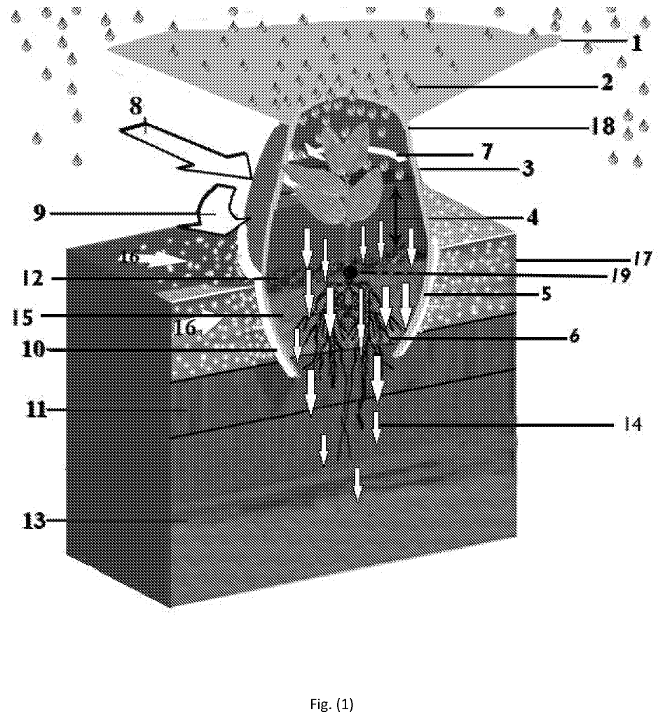

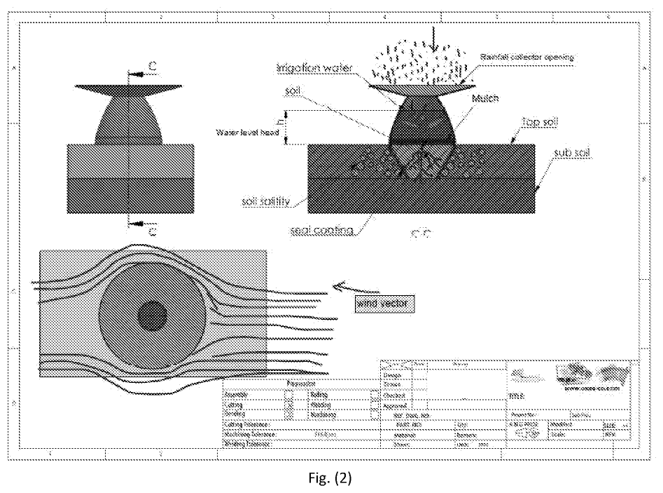

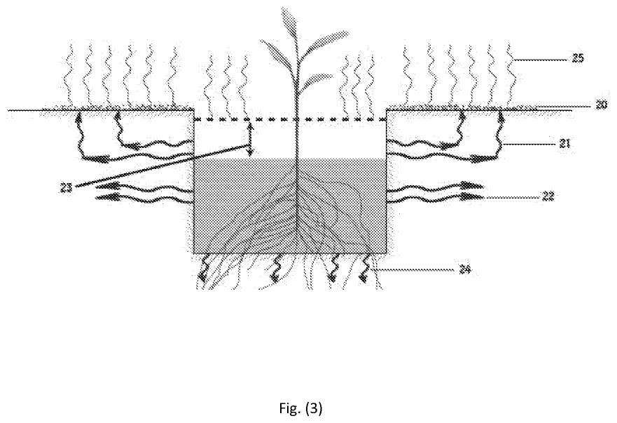

### TECHNICAL BACKGROUND OF INVENTION

This invention can be used in the field of agriculture, planting plants, planting seed, landscaping, and desertification, to protect planted plants or seeds against environmental stresses, including hot or cold winds blowing to the whole aerial parts of newly planted plants (shoot system), at the same time it can protect the lower parts of plants (root system) against the invasion of accumulated salts surrounding the plant root zone especially in saline heavy textured soils. Besides, this apparatus protects planting holes from being filled by fine dust entering from the surface of the soil around the planted plants into planting holes and reducing holes' water storing capacity. In the present invention.

### TECHNICAL PROBLEMS AND THE PURPOSE OF THE INVENTION

Large areas of lands in the world transformed into desert lands typically because of climate changes or drought, in recent years. One of the methods conventionally used to combat desertification is to plant trees in desert lands. However, different environmental stresses have impeded plants planting. So, many of the planted plants die out annually due to environmental stresses. Of these environmental stresses are the high water losses due to evaporation from planting holes after irrigation, blowing of hot, dry winds to aerial parts of the plants, invasion of salinity into plants root zone and entering degraded and alkaline surface soil into planting holes, etc. which individually or collectively can hurt and dry out the plants. High water evaporation losses from planting holes can reduce the available water storage for the plant. Blowing hot, dry winds containing fine particles of salt upraised from the degraded surface of the soil, burning and drying out the aerial parts of the plants resulting into lose their leaves. Entering the saline and degraded soil surface existing around plants into the planting holes, can reduce the water storage capacity of planting holes, on one hand, and the other, the salt entered into the holes being solved by irrigation water and reaching into the root zone which result to salinity stresses of the planted plant. In addition, Irrigation of planted plants in sloping lands is difficult especially when the soil texture is heavy and the percolation rate is low. Because the slope in the ground does not give enough time to the irrigation water to sit upon top of the soil to percolate into the soil, so the percolation depth of water into the root zone soil decreases remarkably. Therefore, in each irrigation, a large portion of water runs off due to the ground's slope, and not only the root zone does not receive a sufficient water, but also running water on soil surface erodes the soil gradually. This invention is, 1—surrounding the plants in order to protect their whole aerial parts (shoot system) from the impacts of environmental stresses such as blowing hot and cold winds (8) & (9), 2—preventing the invasion of accumulated salts from surrounding soil (16) into the plants root collar (19) and root zone (15) by disconnecting the soil between the root zone (15) and the surrounding soil (17), 3—reducing water requirement of plants by increasing water application efficiency, 4—preventing degraded surrounding soil (16), entering into planting holes and reducing their water storage capacity, and 5—motivating the root of plant to follow the moisture downwardly to lower layers of soil, causing the deeper establishment of the planted plant and causing the root system to reach underground water (13) sooner conventional methods of irrigation. Using an earthenware compartment, even in the sloping grounds provide an enough time for the stored water in the water reservoir to be sited upon the root zone soil until all of the irrigation water percolates within the root zone soil, without being wasted of run off, FIG. (2). The key benefit of the present apparatus is its biocompatible gender because it is made of clay. Therefore, extensive use of this apparatus does not harm the environment; also, it is resistant to environmental stresses such as fast winds, high temperatures, successive wetting and drying due to frequent irrigation, and strikes of animals in deserts. It is also commercially can be competitive due to its low price, however due to its low price of production; producing earthenware compartment can be performed within the field of plantation field, hence reducing transportation costs. Additionally, it does not seem to be worthwhile to be stolen, hence, reducing guarding costs.

### BACKGROUNDS

Different inventions have been patented regarding plants protection including the followings. U.S. Pat. No. 3,226,881A, discloses an apparatus which can readily use for the protection of outdoor plants during the cold months of the year. As he has mentioned, the apparatus installed over the plants and can protect aerial parts of plant (shoot system) against environmental stresses. One of the purposes of the invention was to protect plants against cold. Another benefit was its ease of installation, transportation, and storage. It had a gate, which could easily be adjusted to ventilate the air inside the box; the side on the above could be removed for more air circulation. U.S. Pat. No. 5,669,177, discloses plant protection with temperature controller apparatus. Holes are made in the box for air circulation. Holes have caps, which can be removed to allow air to easily enter the box. The box is installed over the plant and can protect the aerial parts of the plants against environmental stresses. U.S. Pat. No. 6,067,747, discloses an apparatus entitled “Plant greenhouse forest protector and growth enhancer”. The box is installed over the plant to protect its aerial parts. The cone-like box has slots from bottom to top. It has slots through which water and air can easily enter the cone. U.S. Pat. No. 2,753,662, discloses a plant protector apparatus. It is most important purpose was to protect the aerial parts of plants. Besides, it is easily installed and transported. The cylinder-like box is connected to the ground by brackets protecting aerial parts of the plants. The cap installed above the box easily being opened and closed. Therefore, it does not prevent rainfall and sunlight is entering the enclosure. The major differences between the mentioned and the present invention is that the mentioned device can only protect the areal parts of the plants while the present invention not only can protect the areal parts of plants from the environmental stresses but also simultaneously can protect the root system by preventing accumulated salinity around the planted plants from invading into the collar root and root zone of plants, by cutting the soil connection between the root zone and the surrounding soil. Other advantages of the present invention in comparison with the above-described inventions, include, reducing water requirement of plants by increasing water application efficiency, preventing entering the degraded and saline surface soil into the planting holes, preventing the reduction of water storage capacity in the planting holes, and down warding the irrigation water vertically to lower layers by disconnecting the soil between the root zone and surrounding soil, resulting to enhance the root system to move vertically to lower layers to reach the underground water, in a shorter time than usual.

In many cases, the present invention may be confused with WO2012081980, which is known under the trademark ‘WATERBOXX’ Groasis. To disclose the differences between the two; the following items are described below:

The waterboxx consists of a box made of polyethylene or biodegradable material that stores water in its container. In addition, due to its special shape, the body of the waterboxx can be placed around the plants so that the body of the waterboxx can prevent hot winds from hitting directly to the aerial parts of the plant. Besides, its shape is designed to be able to collect precipitation and direct the collected rains into its chamber. Moreover, the water in the waterboxx water reservoir is supplied to the root zone soil through a nylon or PLA wick, in a way that the plant root should use a little amount of moisture transferred by the wick capillary tubes. The present earthenware compartment is different from some aspects with waterboxx, from which the following can be explained; a) the way of water supply to the root zone, b) Providing a more protective shelter for the plant in earthenware compartment than waterboxx, and c) the lower part of the earthenware compartment, each of which is briefly explained below: The waterboxx consists of a box made of polyethylene or biodegradable material that stores water in its container. Also, due to its special shape, the body of the waterboxx can be placed around the plants so that the body of the waterboxx can prevent hot winds from hitting directly to the aerial parts of plant. In addition, its shape is designed to be able to collect precipitation and direct collected rains into its chamber. Moreover, the water in the waterboxx reservoir is supplied to the root zone soil through a nylon or PLA wick, in a way that the plant root should use the little amount of moisture transferred by the wick capillary tubes. The present earthenware compartment is different from some aspects with waterboxx, from which the following can be explained; a) the way of water supply to the root zone, b) Providing a more protective shelter for plant in earthenware compartment than waterboxx, and c) the lower part of the earthenware compartment, each of which is briefly explained below:

A) Differences in Terms of Water Supply to the Root Zone:

As described above, the supply of water from waterboxx reservoir to the root zone is done through a wick, so the plant root should use the small amount of moisture transferred by the wick capillary tubes to the root zone, however, in dry areas with hot winds where the rate of evapotranspiration is high and accordingly the water required for plants is more than usual, the moisture in the soil around the wet wick may not be enough to meet the volume of water required for plant evapotranspiration and growth. Therefore, in desert areas with hot winds, the use of waterboxx may lead to drought stress and eventually destroy the plant. On the other hand, because the small amount of moisture, in the wet wick, supplies moisture near to the topsoil and cannot downward water to the lower layers of the soil, using this method can collect roots around the wet wick and slow down the root movement toward deeper layers of the soil. Therefore, it can be expected high-speed winds in deserts may fall down plants cultivated with this method. While, in the earthenware compartment, because the plant is located inside the compartment and at the same time that the compartment is filled by water (4), the plant placed inside the compartment is immersed in water and then almost whole of the irrigation water, after penetrating (14) through the soil inside the compartment (15) toward deeper layers of the soil below. This in turn can stimulate the root to move downward following the water to the deeper layers (11) & (13), which can lead to the better establishment of plants in the soil stronger than that in waterboxx.

B) Shape of the Upper Part of the Earthenware Compartment to Protect the Aerial Parts of Plant:

The following items can be disclosed:

1—Due to the shape of the upper part of the earthenware compartment (3) (slightly smaller diameter of the upper opening (18) than below), the upper part of the compartment (3) extends around the aerial parts of the plant, and creates more enclosed shelter and shade for the plant than the waterboxx, which can help to reduce transpiration in the plant.

2—Because the Interior space volume of earthenware compartment is larger than the waterboxx, the air entering from the upper opening of the earthenware compartment has more volume space to rotate around the plant (7), which can help with proper ventilation and transpiration of the plants.

C) Difference in Ways of Protecting the Root Collar (19) and Root Zone (15):

Successive irrigation operation especially in heavy textured soil, hot weather conditions, or irrigation with brackish water, can cause salts accumulation surrounding collar root and root zone of the plants (19). During exposure to salinity, plants can experience drought stress, reduction in leaf expansion, ironic limitation, etc. Since, the sealed body of the lower part of the earthenware (10) compartment surrounds the root collar (19) and root zone (15), to the depth of root establishment, and cuts the connection between the soil of its inside (root zone) (15) and outside (topsoil surrounding root zone) (17), by creating a sealing barrier between them (10), the salinity in surrounded soil (16) cannot invade the root collar (19) and root zone (15). Therefore, using earthenware compartment can reduce the negative effects of salinization on plants. However, waterboxx does not protect root collar and root zone in such a way.

D) Water Weight Pressure, Caused by the Water Column (4) Created in the Earthenware Compartment after Each Irrigation Operation:

With each irrigation, the earthenware compartment fills with water, which creates a column of water inside its empty volume space (4). The pressure from the elevation of the water column can help the vertical penetration of water into lower layers of the soil (15) and (11), and water at the movement of down warding to the lower layers, can leach the soil of the root zone (15) and push the available salts from the root zone to the lower layer of the soil (11) & (13). Besides, motivating the root system (6) to follow the moisture downward to deeper layers (14) that can help the plant to the better establishment and help the root reaches to underground water (13) sooner than usual.

Technical Solution to the Problem at-Hand, Invention Description:

General Layout of Earthenware Compartment:

The present apparatus is an earthenware compartment with upwardly and downwardly openings, which is made of clay and heated to reach its optimum hardness (FIG. (1) & (2)). Earthenware compartment comprising: a condensation funnel opening (1), a lower part (5), an upper part (3), a soil moisture measuring sensor (20); a global positioning system device (21), an inlet valve (22), an outlet valve (24), nano-seal coating (10), mulching materials (12), and mycorrhizal fungi (6). Each mentioned part individually or together with other parts reduces environmental stresses and increase the survival potential of plants in stressful condition. Which is described as follows:

1) Condensation Funnel Opening:

The Condensation funnel opening (1) is made of clay and disposed on the uppermost part of the earthenware compartment. The Condensation funnel opening, having an above opening (28) and a bottom opening (27). It is configured to condensate precipitations (2) guiding them into the lower parts (3) and (5), and eventually to the root system (6). The condensation funnel is detachable from the upper and the lower part (3) & (5), for the ease of transportation from the factory to the plantation field, so that it attaches from its bottom opening (27) to the above opening of the upper part (18) after the lower and the upper part are installed properly within the soil. Note that in hot, dry weather, which precipitations (2) contribute a very small roll of plant irrigation requirement, and irrigation planning is performed mainly based on irrigation operations, the use of condensation funnel (1) can be skipped, to save the production costs. Besides, the irrigation water can be easily entered through the same opening (1) to the earthenware compartment.

(2) Lower Part of Earthenware Compartment:

This part (5) is open from the above (25) and open from the bottom (26). This part is the first part to be installed within the soil. After digging a planting hole, with dimensions equal to the dimensions of the lower part of the compartment, the lower part should be installed in the depth equal to the height of the lower part, such that the upper edge of its above opening (25) being out of the soil for being attached to the bottom opening of the upper part (24), So that the body of the lower part creates a sealed barrier (10) between the soil of its inside (15) and outside (17). Then, a plant configured to be planted in the soil inside the lower part (15). Before planting the plant, the root of the plant should be impregnated with mycorrhizal fungi (if needed) and the soil should be prepared for planting (15).

Then, to avoid the capillary action, mulching materials (12) should be spread over the soil surface inside the lower part (15). This mulching materials should be fully composted before being used in the earthenware compartment.

(3) Upper Part of Earthenware Compartment

For the ease of transportation and proper establishment of plant in the soil inside the compartment (15), the upper part (3) is detached from the lower part (5) before being installed to the plantation field. So, after the installation of the lower part in the planting hole and as the plant being planted into the soil inside the lower part (15), as explained above, the upper part (3) should be attached from its bottom opening (24) to the above opening of the lower part (25), but the seam between two parts must be fully glued and sealed. So the combination of upper and lower parts creates an empty space for reserving the irrigation water (4), and the water weight created inside mentioned water reservoir due to a column of accumulated water created by filling up the water reservoir with water (4), pushes mentioned water vertically through the root zone soil inside the lower part (15) toward the lower layers under the root zone (11). Also, as explained above, because the sealed body of the lower part (10) disconnects the surrounding soil (17) from root zone soil (15), the irrigation water (4) has no way to run off horizontally over the surrounding soil (17) through passing from the root zone (15). Therefore, the water application efficiency considerably increases and this vertical infiltration (14) can stimulate the root system (6) to follow the moisture to lower layers (11), which motivates the root to reach the underground water (13) in a shorter time than using conventional irrigation methods. The height of the upper part (3) configured to conform with the planted plant such that surrounds the whole of the aerial parts of newly planted plant, and to create a head of accumulated water (4) to downward stored irrigation water (14) to lower layers of soil under the root zone (11). In addition, to reduce evaporation from the earthenware compartment. Note that irrigation water and sunlight enter the compartment, through the above opening (18) of the upper part of the compartment, also in the fields that irrigation is performed using irrigation pipelines, at least an inlet valve configured to couple within the body of the upper part, delivering water from the water pipeline into the water reservoir. In addition, at least one outlet valve being coupled into the body of the upper part entering to the water reservoir from one side and getting out of the water reservoir from another side, that configured to be opened due to prolonged water ponding in the water reservoir more than water requirement for the plant, exiting excess water from the water reservoir.

(4) Application of Nano Seal Coating:

In the conventional operation of planting plants, firstly, a hole in the shape of a cube is dug and a plant is planted within the hole. Then the hole is filled with irrigation water to moisturize the soil of the root zone. However, in deserts with mainly clay soil, which is generally dry and has a great moisture suction, a considerable portion of the available water filled in the hole being horizontally sucked by hole walls, This sucked moisture then reaches the soil surface through capillary ascent to the soil surface and leaves its salt through evaporation losses, which increases the cumulative salinity around the plant after successive irrigation operations, especially when brackish water is applied, devastating the plant, eventually. In addition, the water inside the planting hole losing its water from upside through evaporation losses. Therefore, the total mentioned losses from upside and surrounding hole walls, in turn, reduce irrigation application efficiency. While using the earthenware compartment, the whole amount of irrigation water is stored to its inside, and downward vertically (14) through the soil inside the lower part of the compartment (15) (root zone) to lower layers below the root zone (11). Also, as mentioned above, because the lower part of the earthenware compartment disconnects the surrounding soil (17) from inside soil (15), and because the outside body of the lower part is coated with Nono-seal materials (10), so no moisture can pass through its porous body; also the shape of the upper part of the earthenware compartment reduces the evaporation losses from upside. By such a way can be expected that almost hole of the irrigation water infiltrates vertically downward to the root zone soil and be available for the root system, therefore the efficiency of applied irrigation water can be increased noticeably.

(5) Application of Mulching Materials:

In heavy-textured soils, the water rises to the surface due to the capillary ascent and evaporates leaving its salt on the soil surface. Successive irrigation operation especially in hot weather condition which in turn increase the evaporation rate, gradually leads to an increase of accumulated salts surrounding the plants. This process is called salinization, which finally can increase to toxic levels for plants. Salt in soils can increase the osmotic potential of the soil so that plants cannot take up water from it. When soils become salty, the soil has more concentrations of solute than does the root, so the root of the plant cannot get water from the soil. The evaporation rate plays an important role in this process. Therefore, experts usually recommend some methods to reduce the connection between the capillary pipes in the soil profile and connections between the soil surface and open air. Mixing the soil inside the earthenware compartment with mulching materials can reduce the capillary action considerably; also, spreading mulching materials (12) over the surface soil inside the earthenware compartment (15) in combination with the shape of the upper part of the compartment (3) reduces the evaporation losses rate from the soil surface inside the compartment. Therefore, the application of mulching materials in the earthenware compartment (12) help in the reduction in salts accumulation around the plant (16).

(6) Root Improvement Using Mycorrhizal Fungi:

Plants may increase their resistance in response to stressful environmental conditions such as drought and salinity and nutrient deficiencies in the soil by strengthening their root system. In this regard, mycorrhizal fungi can play an important role in improving plant nutrition and growth. The presence of mycorrhizal fungi and coexistence with the root of many plants in unsuitable soils shows that these fungi can increase the tolerance of plants to environmental stresses by strengthening the root system and shoot system of plants against various stressful conditions such as drought, salinity, temperature, and some diseases.

The application of mycorrhiza fungi brings about the following benefits:
More enduring and healthier plants
Increased efficiency and biomass
Optimization of water application
Ensuring availability of minerals to the plant
Increased survival chances of plants

For this reason, it is considered that the root zone soil inside the earthenware compartment should be impregnated with a mycorrhizal fungus.

(7) Soil Moisture-Measuring Sensor:

Soil moisture measuring sensor configured to be disposed within the root zone having two parts. The first part is a sensor part that is located inside the root zone soil, and the second part is a gauge part that is extended to above the earthenware compartment showing the water requirement of root zone soil.

(8) Global Positioning System Device;

A global positioning system attaches to the condensation funnel or opening, showing the exact location of each earthenware compartment and in collaboration with the soil moisture-measuring sensor draws a map of water requirement of the whole plantation field. Such that in each irrigation period, instead of irrigating the whole plantation field, only those earthenware compartments will be watered that show a low level of moisture in their root zone soil, hence the water consumption will be saved and the irrigation costs will be reduced.

(9) An Inlet Valve:

at least one inlet valve configured to be coupled to the body of said upper part, wherein said inlet valve being connected to an irrigation pipeline from one side and being entered to the water reservoir from another side, delivering water from said pipeline into said water reservoir.

(10) An Outlet Valve:

at least one outlet valve being coupled into the body of said upper part entering to the water reservoir from one side and getting out of the water reservoir from another side, wherein said outlet valve configured to be opened due to prolonged water ponding in said water reservoir more than water requirement for said plant, exiting excess water from the water reservoir.

Application of the Earthenware Compartment in the Plantation Field:

The earthenware has three main parts, comprising: condensation funnel (1), an upper (3) and a lower part (5), all mentioned parts are detachable and capable to be connected during the installation in the plantation field, also they can constructed as an integrated unit and one piece. For the installation of the earthenware compartment, in case of the earthenware compartment is produced as an integrated piece; firstly, a planting hole should be dug; then, the plant root should be impregnated with mycorrhizal fungi before the plant being planted. Secondly, the root zone soil should be mixed with mulching materials, afterward the plant should be planted, lastly the earthenware compartment should be putted into the soil around the planted plant and pushed downwardly, such that the nano coated lower part of the earthenware compartment (5) buried into the soil and surrounds the root zone soil of newly planted plant. In such a way, a nano-sealed barrier (5) is being created between the root zone soil (15) and surrounding soil outside of the earthenware compartment (17), at the next step mulching materials (12) should be spread over the surface of the soil inside the compartment.

### FIGURES, DRAWINGS AND CHARTS

FIG. (1) shows the earthenware compartment. No. 1 is the condensation funnel opening, No. 5 is the lower part, No. 3 is the upper part, No. 10 is the Nano-seal coating, No. 12 is mulch materials over the soil surface inside the compartment. Parts of earthenware compartment are explained in detail in Technical Solution to the Problem At-hand, Invention.

### ADVANTAGES OF INVENTIONS OVER PREVIOUS INVENTIONS

Successful maintenance and transplantation of plants from the nursery to environmentally stressful conditions such as desert areas usually requires some preparations such as going through the habituation period and using plants of one to several years old to withstand environmental stresses. In addition, the establishment of plants in areas with environmental stresses can result in more loss of plants, including the negative effects of wind scorch on leaves. The following explains how the earthenware compartment deals with such conditions to increase the chance of plant survival:

1) Reducing the Habituation Period:

Plants in order to be ready for cultivation in a stressful condition such as the desert, should be stayed out of the nursery for some times before being transplanted from the nursery to the desert, for being adapt to environmental conditions outside of the nursery or greenhouse. This process is called habituation, which requires spending of time and expense. While the earthenware compartment can balance the temperature to some extent by creating a microclimate around the plants, it also prevents hot and cold winds (8) & (9) to hit directly the plant shoots, which in turn prevent damages to the plant. Therefore, if the earthenware compartment is applied, it is possible to skip extra time and cost for habituation, by adapting plants in the earthenware compartment in plantation field.

2) Application of Plants of One or Several Years Old to Improve Planting and Plant Survival Chances in Environmentally Stressful Condition:

Plants with less than one-year-old usually have less tolerance to environmental stresses, such as soil salinity and drought stress, than plants having two or several years old. Therefore, if these very young plants are planted in a stressful condition, before passing some months in the nursery to strengthen their root and root systems, the possibility of their damage and loss increases significantly. Therefore, for planting plants in an unsuitable condition, experts recommend that plants be kept in the nursery for one to several years to increase their root volume, stem diameter, height, and other shoot and root system so that plants to achieve more resistance when displacing and exposing stressful condition. This, in turn, can increase plants' maintenance time in the nursery expenses. While the earthenware compartment by creating a microclimate around the aerial parts of the plants (using the upper part of the earthenware compartment (3)), and protecting the root zone (15) from the invasion of soil salinity (16) and alkaline (using the lower part of the earthenware compartment, (5)) can provide more protected condition to increase the chance of survival of plants with less than one-year-old, in stressful condition, therefore, plants maintenance costs can be considerably reduced.

3) Wind Scorch:

Burning of leaves often occurs in long time periods of dry, windy weather or bright sunshine, like what happens in the desert, when the roots are unable to supply water to the plant shoot system as quickly as it is lost by transpiration from the leaves. While the earthenware compartment prevents hot or cold, dry winds (8) & (9) to hit directly to plants leaves by creating more suitable climatic conditions around the plants. Therefore, using the earthenware compartment can reduce scorch harms on plants, substantially.

4) Leaf Necrosis:

Usually in deserts, with Saline-sodic soil with clay texture, the soil sodicity can cause degradation to structure on the soil surface, which is called soil dispersion. By soil dispersion, the soil structure disintegrates into very fine particles due to the presence of a high level of sodium on the topsoil. Therefore, as soon as the local winds blow, these very fine particles, impregnated with sodium and salt, rise from the soil surface and settle on the leaf surface of plants. Then, with the first-morning dew, these salts by dissolving into water and entering the leaves or accumulating on the surface of the leaves, can increase necrosis in the leaves of plants. While the earthenware compartment (upper part of the earthenware compartment, (3)) protects the plant's leaves from the direct strike of such particles raise with winds (8) & (5). Therefore, these particles can only strike the exterior body of the earthenware compartment (3). In such a way, the earthenware compartment can reduce the negative effects of necrosis on leaves.

5—Protecting the Whole Aerial Parts and Root System of the Plant Simultaneously:

Earthenware compartment, not only can protect the areal parts of plants from the environmental stresses, but also can protect the root system at the same time by preventing accumulated salinity around the plant (16) from invading into the collar root (19) and root zone (15) of plant, by cutting the soil connection between the root zone and the surrounding soil (17).

6—Stimulating Root System to Downwardly Move to Deeper Layers of Soil:

The pressure caused by the weight of the water column created in the water reservoir due to filling up the water reservoir with water in the earthenware compartment (4) percolates the water into the soil and pushes the water to the lower layers (11) of the soil, leaches the soil of the root zone and pushes the available salts from the root zone to the lower layers of the soil. Besides, stimulating the root system to follow the moisture downwardly to deeper layers (11) resulting to a better establishment and the root to reach the underground water (13) sooner than using conventional methods of irrigation.

7—Increasing Water Application Efficiency:

Because the lower part disconnects the surrounding soil from root zone soil, by creating a sealed wall between them (10), the irrigation water has no way to spread horizontally outside the root zone through passing from the root zone, therefore the water application efficiency will be increased.

8—Decreasing the Evapotranspiration from Inside the Earthenware Compartment:

Due to the shape of the upper part of the earthenware compartment (3) (slightly smaller diameter of the upper opening (18) than its below), the upper part of the compartment (3) extends around the aerial parts of the plant and creates an enclosed shelter and shade for the plant, which can help to reduce transpiration. In addition, mixing the soil inside the earthenware compartment with mulching materials can reduce the capillary action considerably; in addition, spreading mulching materials over the surface soil inside the earthenware compartment in combination with reducing the diameter of the above opening of the upper part (18) of the compartment reduces the evaporation losses rate from the soil surface.

9—Sealing Body of the Lower Part of the Compartment:

The body of the earthenware compartment is porous because it is made of clay. After each irrigation, the water can wet the exterior body of the compartment, and salts existing in the soil around the compartment can dissolve to the mentioned moisture and gradually pass the porous body of the lower part of the compartment (5) to the root zone. Sealing the body of the lower part of the compartment (10), prevent the salinity (16) to pass from outside (17) to inside the compartment (11), through its porous wall and enter to the root zone (15).

10—Biocompatibility of the Material and Inexpensive Production:

The key benefits of the present invention include its biocompatible gender, which is made of clay-based earthenware; therefore, extensive use of it does not harm the environment. In addition, it is resistant to environmental damages such as fast winds, high temperatures, successive wetting and drying due to frequent irrigation, and hits by animals in deserts. It is also commercially can be competitive due to its low price; additionally, it does not seem to be worthwhile to be stolen, hence, reducing guarding costs.

11—Creating a Microclimate Inside the Earthenware Compartment:

One of the key characteristics of the earthenware clay compartments is that they can balance the weather inside themselves. The body of the earthenware compartment is porous because it is made of clay. After each irrigation, the water can exit to the exterior body of the upper part of the compartment (3) and as the wind blows to the body of the compartment (8) & (9), the compartment can balance the weather inside itself and create a microclimate inside the compartment. This can bring more freshness to the newly planted plant to survive in environmentally stressful conditions.

12—Enough Sheltered Space for Better Ventilation:

The interior space of the earthenware compartment is large enough for ventilation (7). A fresh air entering from the upper opening of the earthenware compartment has enough volume space to rotate around the plant (7), which can help to proper ventilation and transpiration of the plants.

13—Upper Opening of the Compartment for Receiving Sunlight and Irrigation Water:

Sunlight and irrigation water can easily enter the compartment from the above opening (18).

14—Saving of Excess Irrigation Water Due to the Existence of Condensation Funnel Opening (1):

A clay made opening (1) disposed on the uppermost part of the earthenware compartment (3). In winters, this opening condensate precipitations (2) and guide them into the lower parts and eventually to the root zone (15). In such a way, the irrigation operation periods and the related costs can be reduced.

15—the Role of Mycorrhizal Fungi in the Compartment:

The presence of mycorrhizal fungi and coexistence with the roots of many plants in unsuitable soils shows that these fungi can increase the tolerance of plants to environmental stresses by strengthening the root system and shoot system of plants against various stressful conditions such as drought, salinity, temperature, and some diseases.

16—Down Warding the Irrigation Water Vertically to Lower Layers:

The special shape of the compartment can help down warding the irrigation water vertically (14) to lower layers (11), by disconnecting the soil between the root zone (15) and the surrounding soil (17), resulting to stimulate the root system (6) to follow the moisture toward the lower layers to reach the underground water (13), in a shorter time than usual.

17—Reducing the Habituation Period:

Earthenware compartment can balance the temperature to some extent by creating a small microclimate around the plant; it also prevents hot winds (8) & (9) from hitting directly to the shoots of the plants, which in turn can prevent damages to a plant. Therefore, if the earthenware compartment is used, it is possible to save extra time and cost of habituation period, by adapting plants inside the earthenware compartment, in the place where plants are to be planted.

18—Reducing the Irrigation Period and Related Costs:

When the plant is planted in stressful environments like dry land deserts, the irrigation frequency should be increased to reduce the negative effects of environmental stresses to the newly planted plant, which considerably increases the costs of transferring proper water to deserts and replanting damaged plants, while using earthenware compartments can create a proper microclimate around the plants and protect them (shoot and root system simultaneously) from the environmental hurts. In such a way, it is possible to reduce the cost of replanting and extensive irrigation.

19—Increasing Irrigation Performance in Sloping Lands:

Irrigation of planted plants in sloping lands is difficult especially when the soil texture is heavy and the percolation rate is low. Because the slope in the ground does not give enough time to the water to sit on top of the soil to penetrate into the soil, so the percolation depth of water into the root zone soil decreases remarkably. Therefore, in each irrigation a large portion of water runs off due to the ground's slope, and not only the root zone does not receive a sufficient water, but also running water on soil surface erodes the soil gradually. Therefore, irrigation in such lands is usually associated with high levels of water wastage and soil erosion, and low levels of irrigation efficiencies. While the water reservoir formed by the attachment of said upper and lower parts of the earthenware compartment, and given that the lower part is almost buried into the soil, in such way the reserved water inside the water reservoir have enough time to sit upon the root zone, FIG. (2), being percolated through the root zone and irrigating the root zone soil without being wasted or runoff.

20—Preventing Soil Crakes to Expand to the Root Zone and Damage the Root:

When a heavy texture soil with a large amount of clay exposes to hot, dry weather, the risk of cracking soil increases remarkably. When the soil is wet, clay particles stick together, but as the soil gets dry, clay particles shrink tightly to each other, and soil cracking forms. Cracks of soil can damages the root and penetration of root to soil gets nearly impossible. Root damage from the below and hot, dry weather from the above of the newly planted plant starting to kill the plant. However, in the case of using the earthenware compartment, because the lower part of the earthenware compartment is almost buried in the soil, it can prevent the cracks to expand to the root zone by making a nano-sealed wall between the root zone soil and surrounding soil from below, and sheltering and creating a microclimate around the shoot system from the top, can increase the survival chance of newly planted plant, remarkably.

21) Capability of Installing Smart Irrigation Devices, Soil Moisture Measuring Sensors and Global Positioning Systems on the Earthenware Compartment:

Earthenware compartment has the capability of installing modern irrigation equipment such as smart irrigation devices, soil moisture measuring sensors for irrigation scheduling, and global positioning systems on it. Wherein the soil moisture measuring sensors in collaborating with the global positioning systems can draw a map of water requirement in the field. Such that in each irrigation period, instead of irrigating the whole of the field, only those earthenware compartments will be watered that show a low level of moisture in their root zone soil, hence the water consumption will be saved and the irrigation costs will be reduced.

22) The Body of Said Upper Part is Paintable and Capable to Envelop with Grass or Flowers:

When the earthenware compartment used in urban fields in which the environmental harsh do not harm the newly planted plant, for the purpose of beautification, the body of the earthenware compartment can be painted or enveloped with planted grass or flowers.

Application of the Invention:

Earthenware compartment can be used in a biologic operation aiming at desertification to protect planted plants against environmental stresses and increase irrigation water efficiency. In urban environments and green belts in large cities as well as places where water transmission through pipes is not practically possible, earthenware compartment can increase water application efficiency increasing plant's survival chances. It can also be used across cities to plant plants that are more normally affected by environmental stresses. The application of mycorrhizal fungi applied in earthenware compartments can improve the root system of plants to resist dryness and salinity.

### INDUSTRIAL AND COMMERCIAL APPLICATION

1—It is a low price plant protector apparatus against Environmental stress.

2—Availability of producing materials every ware.

3—Its ease of use so that indigenous people in rural and desert areas are able to use it without the need for much knowledge and techniques.

4—Water transferring cost saving:

Using an earthenware compartment can create a proper microclimate around the plants and protect the (shoot and root system simultaneously) plant from the environmental stresses so that the irrigation frequency and related costs can be reduced.

5—it is a Biocompatible Industry:

The key benefits of the present invention include its biocompatible gender, which is made from clay-based earthenware; therefore, extensive use of it does not harm the environment.

6—Because the production of earthenware compartments is easy, so the participation of the indigenous people of each region can be used in the production processes, which in addition to creating employment for indigenous people, can reduce the transferring costs of earthenware compartments to planting regions.

7—In desert areas with the stressful environmental condition, the number of plants lost after planting is usually high, which can significantly lead to an increase in the cost of replantation and re-irrigation. While the earthenware compartment can work as a small local greenhouse and create a suitable microclimate around each newly planted plant. Therefore, by using earthenware compartments the number of plants lost due to stressful environmental conditions reduces to almost zero.

This invention can be used by:
National Organization of Forests, Rangelands Watershed Management, to increase irrigation efficiency and survival chances of plants or seeds in desertification projects
Municipalities to increase irrigation efficiency and survival chances of newly planted plants as well as plants with higher sensitivity to environmental stresses, urban green belts and places exposed to environmental stresses such as highways or areas where water transmission is not practically possible by pipelines. By using earthenware compartments, plants with lower tolerance against cold can be planted in cold areas, while plants with lower tolerance against heat and dryness can be planted in warm areas by creating a microclimate around the plants.
National Organization of Agriculture and horticulture, in areas where water transmission is not practically possible by pipelines or ditches, using earthenware compartments can help considerably to increase water application efficiency in gardens and growing medical herbs, etc.

1. Nano-coated earthenware compartment plant protector, comprising:
a) a condensation funnel comprising a top opening and a bottom opening, attaching vertically to above an upper part of the earthenware compartment, configured to direct condensate water into a water reservoir in the earthenware compartment;
b) an upper part of the earthenware compartment, comprising: an above opening portion and bottom opening portion, standing vertically between the said condensation funnel from its above opening, and a lower part of the earthenware compartment from its bottom opening;
c) an inlet valve;
d) an outlet valve;
e) soil moisture measuring sensor;
f) a global positioning system device;
g) a lower part of the earthenware compartment, comprising: an open top portion and an open bottom portion, standing vertically under said upper part of the earthenware compartment from its above opening and burying within the soil from its bottom opening in a depth such that at least the upper edge of its above opening remaining out of the ground for being coupled with said upper part of the earthenware compartment;
h) nano sealing materials;
i) mulching materials; and
i) mycorrhizal fungi.

2. According to claim (1), said upper part, wherein said upper part surrounding the whole of shoot system of a newly planted plant protecting said shoot system from environmental harsh and physical strikes.

3. According to claim (1), said upper part in configured to create a moderated microclimate weather inside the earthenware compartment due to its air moderating properties of its porous body. Wherein, said moderated microclimate configured to reduce the excess of evapotranspiration from said plant.

4. According to claim (1), the diameter of the above opening portion of said upper part configured to be smaller than the diameter of the bottom opening portion, wherein reduced opening at the above of said upper part reducing the evaporation losses from the earthenware compartment, thereby reducing the irrigation frequency and costs of unnecessarily excess irrigation.

5. According to claim (1), said upper part with attaching to said lower part, constructing an empty space, wherein said empty space, functioning as a water reservoir, configured to receive water from condensation funnel and an irrigation pipeline.

6. According to claim (1), a weight of accumulated water, formed due to filling said reservoir with water, configured to push said water to percolate vertically into lower layers of soil, thereby leaching the root zone soil and pushing available salinity in the root zone soil to lower layers of soil under said earthenware compartment.

7. According to claim (1), pushing said accumulated water into lower layers of soil, motivating the root of said plant to follow the moisture downwardly to lower layers of soil, thereby causing the deeper establishment of the planted plant and causing the root system to reach underground water sooner than using conventional methods of irrigation.

8. According to claim (1), at least a soil measuring moisture sensor, configured to dispose within the root zone soil, comprising two parts: a sensor part locating within the root zone soil measuring moisture of the soil, and a gauge part disposing above the earthenware compartment, showing the water requirement in the root zone soil.

9. According to claim (1), at least one inlet valve configured to be coupled to the body of said upper part, wherein said inlet valve being connected to an irrigation pipeline from one side and being entered to the water reservoir from another side, delivering water from said pipeline into said water reservoir.

10. According to claim (1), at least one outlet valve being coupled into the body of said upper part entering to the water reservoir from one side and getting out of the water reservoir from another side, wherein said outlet valve configured to be opened due to prolonged water ponding in said water reservoir more than water requirement for said plant, exiting excess water from the water reservoir.

11. According to claim (1), at least one global positioning system configured to dispose above the condensation funnel opening; showing the exact location of each earthenware compartment in the whole plantation field, thereby by collaborating with said soil moisture measuring sensor showing the exact location of each earthenware compartment requiring water.

12. According to claim (1), said lower part comprising a nano-seal coating materials. Wherein covering the body of said lower part, constructing a sealed wall between the root zone soil inside said lower part and surrounding soil outside said lower part, preventing the osmotic movement of salinity entering from the surrounding soil into the root zone soil through pores of the body of said lower part.

13. According to claim (1), said mulching materials configured to mix with the root zone soil inside said lower part preventing the rise of salinity causing by the capillary action and spread over the soil surface inside said lower part reducing the evaporation losses from the soil surface inside said lower part, thereby reducing the salt accumulation over said soil surface causing by the capillary action and evaporation losses.

14. According to claim (1), said mycorrhizal fungi configured to impregnate the root of said plant, improving said root micronutrients adsorption from the root zone soil.

15. According to claim (1), said condensation funnel opening, and said upper part and lower part are biocompatible and constructed from clay.

16. According to claim (1), said condensation funnel opening, and said upper and lower parts of the earthenware compartments are detachable and configured to be attached together during the installation in the plantation field, or be constructed as an integrated unit and one piece.

17. According to claim (1), the earthenware compartment having at least a handle for the ease of being moved.

18. According to claim (1), the external body of said upper part configured to be painted or enveloped with grass or flowers.

19. According to claim (1), said upper and lower parts are configured to be coupled together constructing a water reservoir, wherein said water reservoir, providing enough time for reserved water inside said water reservoir being sited upon the root zone soil and being percolated into said root zone soil without being wasted or runoff. Thereby increasing irrigation performance, especially in sloping grounds.

20. According to claim (1), the shape, size, and dimensions of said condensation funnel opening and upper and lower parts configured to be conformed according to the environmental conditions, plant size, and ground slops.
